(19) United States
(12) Patent Application Publication
(10) Pub. No.: US 2026/0111060 A1
(43) Pub. Date: Apr. 23, 2026

(54) ELECTRONIC DEVICE

(71) Applicant: Acer Incorporated, New Taipei City (TW)

(72) Inventors: Hua-Feng Hsieh, New Taipei City (TW); Chun-Hsien Chen, New Taipei City (TW); Hui-Ping Sun, New Taipei City (TW); Chun-Hung Wen, New Taipei City (TW); Yen-Chou Chueh, New Taipei City (TW); Chun-Hsien Wu, New Taipei City (TW); Chi-Yuan Liu, New Taipei City (TW)

(73) Assignee: Acer Incorporated, New Taipei City (TW)

(21) Appl. No.: 19/215,289

(22) Filed: May 21, 2025

(30) Foreign Application Priority Data
Oct. 21, 2024 (TW) 113139950

(51) Int. Cl. G06F 1/16

(52) U.S. Cl. CPC G06F 1/1669; G06F 1/1679

(57) ABSTRACT

Provided is an electronic device including a body, a locking structure, and a keyboard. The locking structure is slidably disposed on the body and has an unlocking slot and a locking slot communicated with the unlocking slot. The keyboard is detachably mounted on the body, where the keyboard is provided with a positioning member inserted into the body and the positioning member is inserted into either the unlocking slot or the locking slot. When the locking structure slides relative to the positioning member, moving the positioning member from the unlocking slot to the locking slot, the locking structure locks the keyboard to the body. When the locking structure slides relative to the positioning member, moving the positioning member from the locking slot to the unlocking slot, the locking restriction of the keyboard by the locking structure is released.

### CROSS-REFERENCE TO RELATED APPLICATION

This application claims the priority benefit of Taiwan application serial no. 113139950, filed on Oct. 21, 2024. The entirety of the above-mentioned patent application is hereby incorporated by reference herein and made a part of this specification.

### BACKGROUND

### Technical Field

This disclosure relates to a disassembly and assembly design, and in particular, to a disassembly and assembly design of an electronic device.

### Description of Related Art

Keyboards, as a common physical input device in laptop computers, are usually secured to the body by multiple screws. During the process of disassembling or assembling the keyboard, the user needs to loosen or tighten multiple screws, which is not only time consuming but also laborious, resulting in inefficient disassembly and assembly.

### SUMMARY

The disclosure provides an electronic device, capable of improving efficiency of disassembly and assembly.

The disclosure proposes an electronic device, including a body, a locking structure, and a keyboard. The locking structure is slidably disposed on the body and has an unlocking slot and a locking slot communicated with the unlocking slot. The keyboard is detachably mounted on the body. The keyboard has a positioning member inserted into the body, and the positioning member is inserted into either the unlocking slot or the locking slot. When the locking structure slides relative to the positioning member and moves the positioning member from the unlocking slot to the locking slot, the locking structure locks the keyboard to the body. When the locking structure slides relative to the positioning member and moves the positioning member from the locking slot to the unlocking slot, a locking restriction of the keyboard by the locking structure is released.

Based on the above, the user only needs to manually control the locking structure slidably disposed on the body to lock the keyboard on the body or release the locking restriction of the keyboard on the body, so as to quickly mount and fix the keyboard on the body or detach the keyboard from the body.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate example embodiments of the disclosure and, together with the description, serve to explain the principles of the disclosure.

FIG. 1A and FIG. 1B are schematic diagrams of an electronic device according to an embodiment of the disclosure from two different perspectives.

FIG. 2A and FIG. 2B are partial cross-sectional schematic diagrams of the electronic device in FIG. 1A along a line 2A to 2A, respectively showing the relative positional relationship between a positioning member and a locking structure in a locked state and an unlocked state.

FIG. 3A and FIG. 3B are enlarged schematic diagrams of an internal structure of the electronic device in FIG. 1A, respectively showing the relative positional relationship of the positioning member and the locking structure in the locked state and the unlocked state.

### DESCRIPTION OF THE EMBODIMENTS

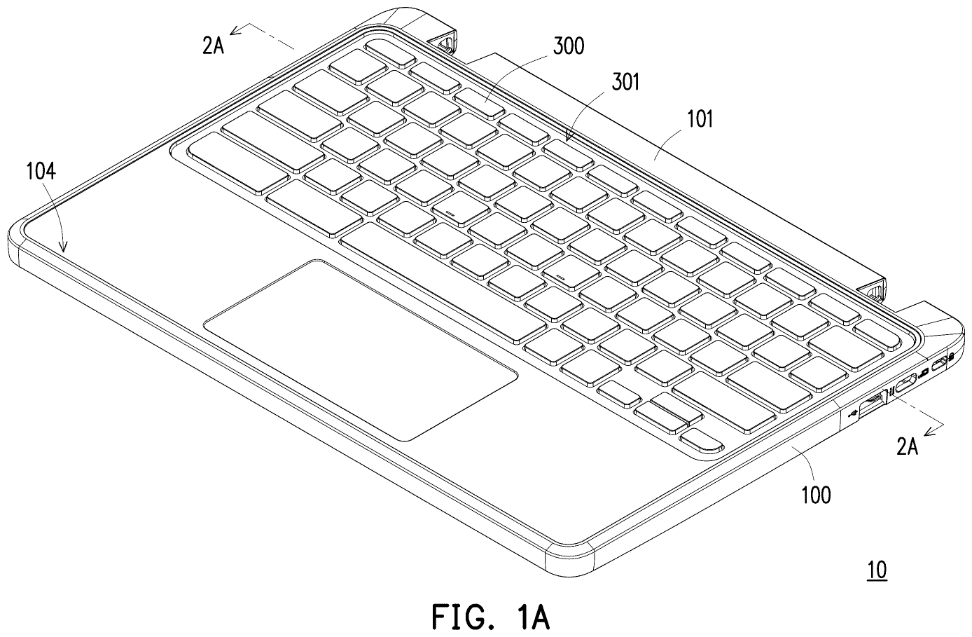

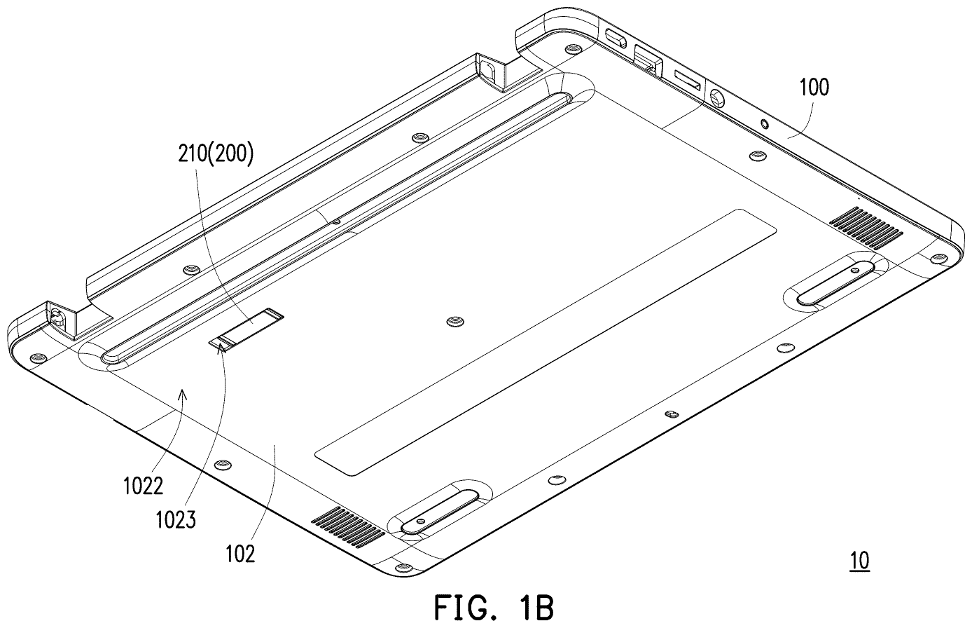

FIG. 1A and FIG. 1B are schematic diagrams of an electronic device according to an embodiment of the disclosure from two different perspectives. Referring to FIG. 1A and FIG. 1B, in this embodiment, an electronic device 10 may be a part of a laptop computer and includes a body 100, a locking structure 200, and a keyboard 300. The keyboard 300 is detachably mounted on the body 100, and a user only needs to manually control the locking structure 200 to lock the keyboard 300 on the body 100 or release the locking restriction of the keyboard 300 on the body 100, so as to quickly mount and fix the keyboard 300 on the body 100 or detach the keyboard 300 from the body 100.

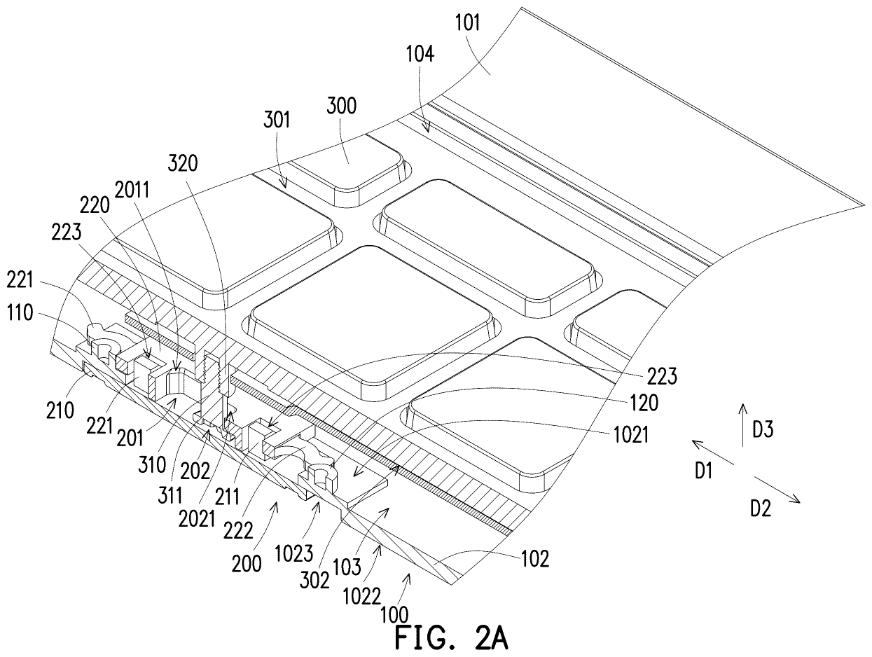

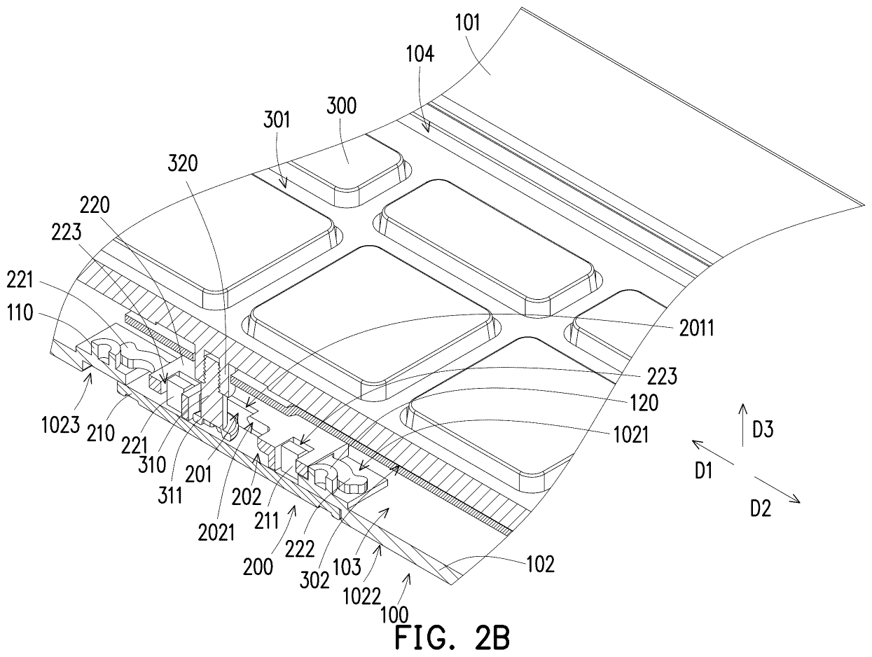

FIG. 2A and FIG. 2B are partial cross-sectional schematic diagrams of the electronic device in FIG. 1A along a line 2A to 2A, respectively showing the relative positional relationship between a positioning member and a locking structure in a locked state and an unlocked state. Referring to FIG. 1A, FIG. 2A, and FIG. 2B, in this embodiment, the locking structure 200 is slidably disposed on the body 100 and has an unlocking slot 201 and a locking slot 202 communicated with the unlocking slot 201. On the other hand, the keyboard 300 has a positioning member 310 inserted into the body 100, and the positioning member 310 is inserted into either the unlocking slot 201 or the locking slot 202.

As shown in FIG. 2A and FIG. 2B, the user can manually control the locking structure 200, so that the locking structure 200 slides relative to the positioning member 310 in a first direction D1, and so that the positioning member 310 moves from the unlocking slot 201 to the locking slot 202. When the positioning member 310 is positioned in the locking slot 202, the locking structure 200 locks the keyboard 300 to the body 100, and generates a structural limit on the positioning member 310 in a third direction D3, which is perpendicular to the first direction D1, stopping the keyboard 300 from moving farther away from the locking structure 200 in the third direction D3 to secure the keyboard 300 to the body 100.

In contrast, the user can manually control the locking structure 200, so that the locking structure 200 slides relative to the positioning member 310 in a second direction D2 that is opposite and parallel to the first direction D1, and so that the positioning member 310 moves from the locking slot 202 to the unlocking slot 201. When the positioning member 310 is positioned in the unlocking slot 201, the locking restriction of the keyboard 300 by the locking structure 200 is released. That is, the locking structure 200 has no structural limit on the positioning member 310 in the third direction D3, so that the user can move the keyboard 300 away from the locking structure 200 in the third direction D3 to detach the keyboard 300 from the body 100.

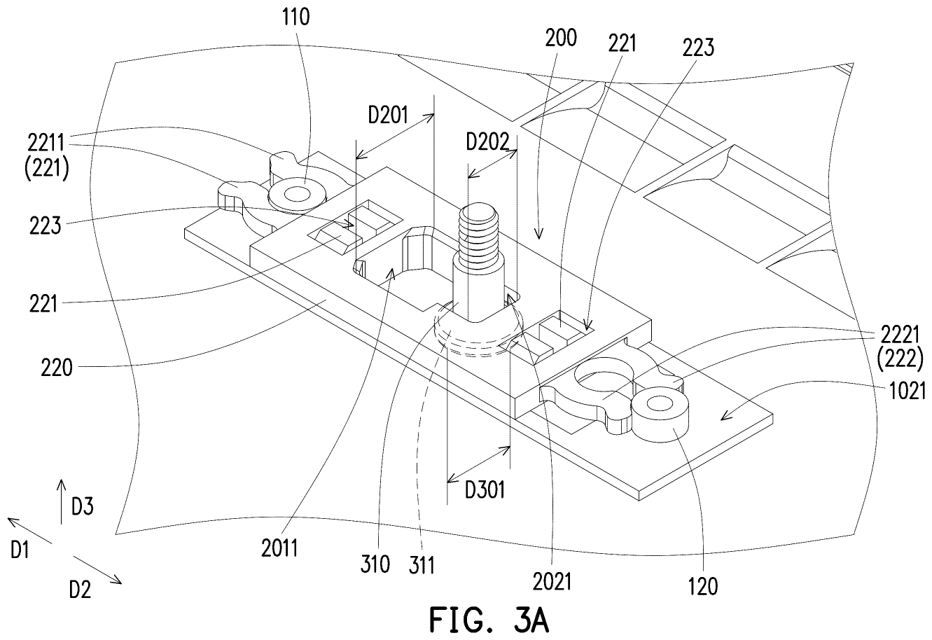

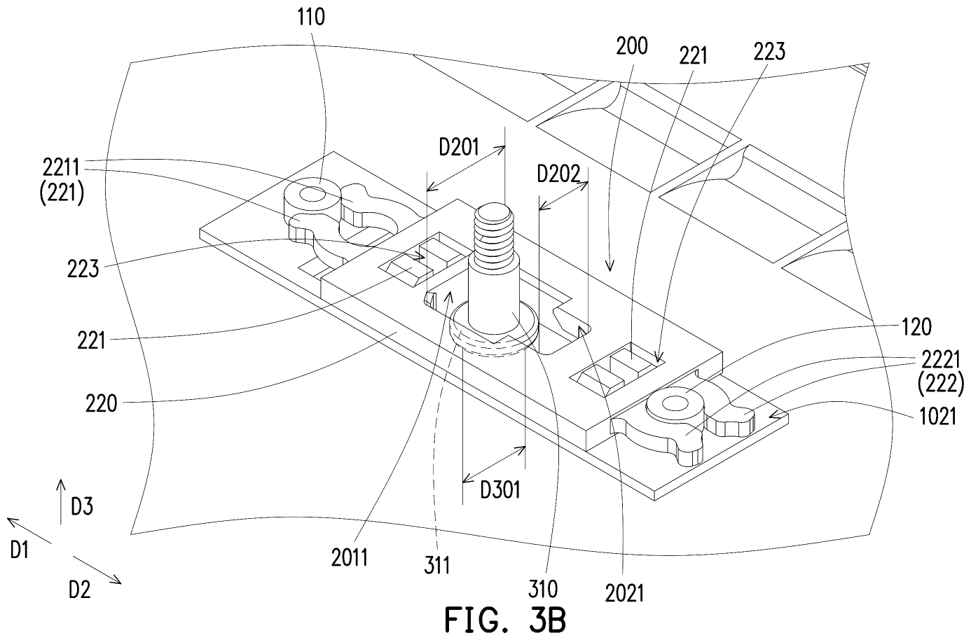

FIG. 3A and FIG. 3B are enlarged schematic diagrams of an internal structure of the electronic device in FIG. 1A, respectively showing the relative positional relationship of the positioning member and the locking structure in the locked state and the unlocked state. Referring to FIG. 2A, FIG. 2B, FIG. 3A, and FIG. 3B, in this embodiment, the unlocking slot 201 has an unlocking opening 2011 facing the keyboard 300, and the locking slot 202 has a locking opening 2021 facing the keyboard 300. In detail, the unlocking opening 2011 is larger than the locking opening 2021, that is, an inner dimension D201 of the unlocking opening 2011 is larger than an inner dimension D202 of the locking opening 2021.

On the other hand, the positioning member 310 includes a positioning head 311 inserted into either the unlocking slot 201 or the locking slot 202. Further, the positioning head 311 is positioned through the unlocking opening 2011 to be inserted into the unlocking slot 201. When the locking structure 200 slides in the first direction D1, the positioning head 311 moves from the unlocking slot 201 to the locking slot 202. Furthermore, the inner dimension D201 of the unlocking opening 2011 is larger than an outer dimension D310 of the positioning head 311, and the inner dimension D202 of the locking opening 2021 is smaller than an outer dimension D310 of the positioning head 311.

Since the inner dimension D202 of the locking opening 2021 is smaller than the outer dimension D310 of the positioning head 311, when the positioning head 311 of the positioning member 310 is positioned in the locking slot 202, the locking structure 200 generates a structural limit on the positioning head 311 of the positioning member 310 in the third direction D3, so that the positioning member 310 cannot move out of the locking slot 202 through the locking opening 2021 in the third direction D3 to secure the keyboard 300 to the body 100.

On the other hand, since the inner dimension D201 of the unlocking opening 2011 is larger than the outer dimension D310 of the positioning head 311, when the positioning head 311 of the positioning member 310 is positioned in the unlocking slot 201, the locking structure 200 does not generate a structural limit on the positioning head 311 of the positioning member 310 in the third direction D3, so that the positioning member 310 can move out of the unlocking slot 201 through the unlocking opening 2011 in the third direction D3 to detach the keyboard 300 from the body 100.

Referring to FIG. 2A and FIG. 3A or referring to FIG. 2B and FIG. 3B, in this embodiment, the keyboard 300 has a keyboard side 301 and a bottom side 302 opposite to the keyboard side 301. The bottom side 302 faces the locking structure 200, and the positioning member 310 protrudes from the bottom side 302. Furthermore, the keyboard 300 is also provided with a screw post 320 protruding from the bottom side 302, and the positioning member 310 is a positioning screw screwed to the screw post 320.

For example, the user can rotate the positioning member 310 to increase the screwing depth of the positioning member 310 in the screw post 320, and accordingly reduce the protruding height of the positioning member 310 on the bottom side 302, that is, reduce the distance between the positioning head 311 of the positioning member 310 and the bottom side 302. As the protruding height of the positioning member 310 on the bottom side 302 or the distance between the positioning head 311 of the positioning member 310 and the bottom side 302 decreases, the keyboard side 301 of the keyboard 300 mounted on the body 100 falls.

Correspondingly, the user can also rotate the positioning member 310 to reduce the screwing depth of the positioning member 310 in the screw post 320, and accordingly increase the protruding height of the positioning member 310 on the bottom side 302, that is, increase the distance between the positioning head 311 of the positioning member 310 and the bottom side 302. As the protruding height of the positioning member 310 on the bottom side 302 or the distance between the positioning head 311 of the positioning member 310 and the bottom side 302 increases, the keyboard side 301 of the keyboard 300 mounted on the body 100 rises.

In some examples, the user can first rotate the positioning member 310 as needed to change the screwing depth of the positioning member 310 in the screw post 320 and correspondingly change the protruding height of the positioning member 310 on the bottom side 302. Next, the keyboard 300 is mounted and fixed on the body 100 to ensure that the keyboard side 301 is maintained at the expected height. In other words, the height of the keyboard side 301 can be flexibly adjusted by the user.

In some examples, in response to bodies with different thicknesses, the user can rotate the positioning member 310 to change the screwing depth of the positioning member 310 in the screw post 320 and correspondingly change the protruding height of the positioning member 310 on the bottom side 302. Accordingly, when the keyboard 300 is mounted and fixed on bodies with different thicknesses, the keyboard side 301 can be ensured to be maintained at an ideal height. That is, the keyboard 300 can be universally used for bodies with different thicknesses.

Referring to FIG. 1A, FIG. 1B, and FIG. 2A, in this embodiment, the body 100 has a top 101, a bottom 102 opposite to the top 101, and an internal space 103 between the top 101 and the bottom 102. In detail, the keyboard 300 is detachably mounted on the top 101, and the positioning member 310 is inserted into the inner space 103. On the other hand, the locking structure 200 includes an external control member 210 slidably disposed on the bottom 102 and an internal locking member 220 connected to the external control member 210. The external control member 210 is disposed outside the internal space 103, and the internal locking member 220 is disposed in the internal space 103.

Referring to FIG. 2A, FIG. 2B, FIG. 3A, and FIG. 3B, the positioning member 310 of the keyboard 300 is inserted into the internal locking member 220, that is, the unlocking slot 201 and the locking slot 202 are disposed in the internal locking member 220. The user can manually control the external control member 210 to slide in the first direction D1 or the second direction D2, and drive the internal locking member 220 to slide synchronously, so as to use the internal locking member 220 to generate a structural limit on the positioning member 310 in the third direction D3, or release the structural limit generated by the internal locking member 220 on the positioning member 310 in the third direction D3.

On the other hand, the body 100 is provided with a locking limiting post 110 and an unlocking limiting post 120 opposite to the locking limiting post 110 in the internal space 103, and the internal locking member 220 is limited to slide between the locking limiting post 110 and the unlocking limiting post 120. Furthermore, the internal locking member 220 is provided with a locking engaging portion 221 facing the locking limiting post 110 and an unlocking engaging portion 222 facing the unlocking limiting post 120. The unlocking slot 201 is located between the locking limiting post 110 and the locking slot 202, and the locking slot 202 is located between the unlocking slot 201 and the unlocking limiting post 120.

Referring to FIG. 2A, FIG. 2B, FIG. 3A, and FIG. 3B, when the internal locking member 220 slides in the first direction D1, the locking engaging portion 221 moves to and engages with the locking limiting post 110, so that the positioning member 310 moves to the locking slot 202, and the unlocking engaging portion 222 is separated from the unlocking limiting post 120. Correspondingly, when the inner locking member 220 slides in the second direction D2, the unlocking engaging portion 222 moves to and engages with the unlocking limiting post 120, so that the positioning member 310 moves to the unlocking slot 201, and the locking engaging portion 221 is separated from the locking limiting post 201.

Referring to FIG. 1B, FIG. 2A, and FIG. 2B, the top 101 has a groove 104 connected to the internal space 103, and the keyboard 300 is positioned in the groove 104. On the other hand, the bottom 102 has an inner surface 1021 facing the bottom side 302 of the keyboard 300, a bottom surface 1022 opposite to the inner surface 1021, and a chute 1023 connected to the internal space 103. The inner surface 1021 is located in the inner space 103, and the chute 1023 penetrates from the bottom surface 1022 to the inner surface 1021.

The external control member 210 is slidably disposed in the chute 1023. The internal locking member 220 is slidably disposed on the inner surface 1021, and the locking limiting post 110 and the unlocking limiting post 120 protrude from the inner surface 1021. In the projection direction parallel to the third direction D3, the unlocking slot 201 and the locking slot 202 overlap the chute 1023.

Referring to FIG. 2A, FIG. 2B, FIG. 3A, and FIG. 3B, the internal locking member 220 also has two slots 223. The unlocking slot 201 and the locking slot 202 are located between the two slots 223, and the two slots 223 are located between the locking engaging portion 221 and the unlocking engaging portion 222. On the other hand, the external control member 210 has two hooks 211, and the two hooks 211 are respectively engaged and fixed to the two slots 223.

For example, the locking engaging portion 221 includes a pair of clamping elastic arms 2211 for clamping the locking limiting post 110 to fix the locking structure 200 in the locking position. In addition, the unlocking engaging portion 222 includes a pair of clamping elastic arms 2221 for clamping the unlocking limiting post 120 to fix the locking structure 200 in the unlocking position.

To sum up, the user only needs to manually control the locking structure slidably disposed on the body to lock the keyboard on the body or release the locking restriction of the keyboard on the body, so as to quickly mount and fix the keyboard on the body or detach the keyboard from the body. In some examples, the user can adjust the protruding height of the positioning member of the keyboard on the bottom according to needs, so that the height of the keyboard side of the keyboard rises or falls relatively, or the keyboard can be used universally on bodies with different thicknesses.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electronic device, comprising:
a body;
a locking structure, slidably disposed on the body and has an unlocking slot and a locking slot communicated with the unlocking slot; and
a keyboard, detachably mounted on the body, wherein the keyboard is provided with a positioning member inserted into the body, and the positioning member is inserted into either the unlocking slot or the locking slot,
when the locking structure slides relative to the positioning member and moves the positioning member from the unlocking slot to the locking slot, the locking structure locks the keyboard to the body,
when the locking structure slides relative to the positioning member and moves the positioning member from the locking slot to the unlocking slot, a locking restriction of the keyboard by the locking structure is released.

2. The electronic device according to claim 1, wherein the keyboard has a keyboard side and a bottom side opposite to the keyboard side, the bottom side faces the locking structure, and the positioning member protrudes from the bottom side.

3. The electronic device according to claim 2, wherein the keyboard is also provided with a screw post protruding from the bottom side, and the positioning member is a positioning screw screwed to the screw post.

4. The electronic device according to claim 1, wherein the body has a top, a bottom opposite to the top, and an internal space between the top and the bottom, the keyboard is detachably mounted on the top, the positioning member is inserted into the internal space, and the locking structure comprises an external control member slidably disposed on the bottom and an internal locking member connected to the external control member, wherein the internal locking member is disposed in the internal space, and the unlocking slot and the locking slot are disposed in the internal locking member.

5. The electronic device according to claim 4, wherein the internal locking member is adapted to slide synchronously with the external control member, the body is provided with a locking limiting post and an unlocking limiting post opposite to the locking limiting post in the internal space, and the internal locking member is limited to slide between the locking limiting post and the unlocking limiting post.

6. The electronic device according to claim 5, wherein the internal locking member is provided with a locking engaging portion facing the locking limiting post and an unlocking engaging portion facing the unlocking limiting post, the unlocking slot is located between the locking limiting post and the locking slot, and the locking slot is located between the unlocking slot and the unlocking limiting post,
when the locking engaging portion moves to and engages with the locking limiting post, the positioning member moves to the locking slot, and the unlocking engaging portion is separated from the unlocking limiting post,
when the unlocking engaging portion moves to and engages with the unlocking limiting post, the positioning member moves to the unlocking slot, and the locking engaging portion is separated from the locking limiting post.

7. The electronic device according to claim 6, wherein the bottom has an inner surface facing the keyboard and a bottom surface opposite to the inner surface, the inner surface is located in the inner space, the internal locking member is slidably disposed on the inner surface, and the locking limiting post and the unlocking limiting post protrudes from the inner surface.

8. The electronic device according to claim 6, wherein both the locking engaging portion and the unlocking engaging portion comprise a pair of clamping elastic arms.

9. The electronic device according to claim 4, wherein the internal locking member also has two slots, the unlocking slot and the locking slot are located between the two slots, the external control member has two hooks, and the two hooks are respectively engaged and fixed to the two slots.

10. The electronic device according to claim 4, wherein the top has a groove connected to the internal space, and the keyboard is positioned in the groove.

11. The electronic device according to claim 4, wherein the bottom has a chute connected to the internal space, and the external control member is slidably disposed in the chute.

12. The electronic device according to claim 11, wherein the unlocking slot and the locking slot overlap the chute.

13. The electronic device according to claim 1, wherein the unlocking slot has an unlocking opening facing the keyboard, the locking slot has a locking opening facing the keyboard, the positioning member comprises a positioning head inserted into either the unlocking slot or the locking slot, wherein an inner dimension of the unlocking opening is larger than an outer dimension of the positioning head, and an inner dimension of the locking opening is smaller than an outer dimension of the positioning head.
